(19) United States
(12) Patent Application Publication
(10) Pub. No.: US 2009/0212850 A1
(43) Pub. Date: Aug. 27, 2009

(54) Method and Circuit for Implementing Efuse Resistance Screening

(76) Inventors: Anthony Gus Aipperspach, Rochester, MN (US); Toshiaki Kirihata, Poughkeepsie, NY (US); Phil Christopher Felice Paone, Rochester, MN (US); Brian Joy Reed, Rochester, MN (US); David Edward Schmitt, Rochester, MN (US); Gregory John Uhlmann, Rochester, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 12/037,176

(22) Filed: Feb. 26, 2008

(51) Int. Cl. H01H 37/76

(52) U.S. Cl. 327/525

(57) ABSTRACT

A method and circuit for implementing eFuse resistance screening, and a design structure on which the subject circuit resides are provided. An eFuse is sensed using a first reference resistor. Responsive to the eFuse being sensed as blown with the first reference resistor, the eFuse is sensed using a second reference resistor having a higher resistance than the first reference resistor. Responsive to the eFuse being sensed as unblown with the second reference resistor, the eFuse is recorded as poorly blown. Reliability concerns are identified quickly and accurately without being required to measure the resistance of the eFuse.

### FIELD OF THE INVENTION

The present invention relates generally to the data processing field, and more particularly, relates to a method and circuit for implementing eFuse resistance screening, and a design structure on which the subject circuit resides.

### DESCRIPTION OF THE RELATED ART

Electronic Fuses (eFuses) are currently used to configure elements after the silicon masking and fabrication process. These fuses typically are used to configure circuits for customization or to correct silicon manufacturing defects and increase manufacturing yield.

In very large scale integrated (VLSI) chips, it is common to have fuses, such as eFuses that can be programmed for various reasons. Among these reasons include invoking redundant elements in memory arrays for repairing failing locations or programming identification information.

When an eFuse is blown the final resistance of the eFuse has a distribution depending upon how well electromigration has occurred. How well electromigration occurs depends upon the amount voltage across the eFuse and amount of current through the eFuse.

Due to process, voltage, and current variation typically when an eFuse does not blow correctly results in a resistance, which is lower than expected. This lower resistance causes a problem in the ability to accurately sense if an eFuse is blown or not. Lower resistance of a blown eFuse is also a reliability concern.

The current solution to this problem is to measure the resistance of the eFuse before and after a blow at test. A significant drawback of this solution is the required large tester time to measure the resistance of every eFuse in bigger arrays. Also the resistance measurement is not entirely accurate due to leakage current from other devices in a path.

A need exists for an enhanced mechanism to quickly and accurately determine if an eFuse is blown properly or not.

### SUMMARY OF THE INVENTION

Principal aspects of the present invention are to provide a method and circuit for implementing eFuse resistance screening, and a design structure on which the subject circuit resides. Other important aspects of the present invention are to provide such method and circuit for implementing eFuse resistance screening substantially without negative effect and that overcome many of the disadvantages of prior art arrangements.

In brief, a method and circuit for implementing eFuse resistance screening, and a design structure on which the subject circuit resides are provided. An eFuse is sensed using a first reference resistor. Responsive to the eFuse being sensed as unblown with the first reference resistor, the eFuse is recorded as unblown and this completes the screening. Responsive to the eFuse being sensed as blown with the first reference resistor, the eFuse is sensed using a second reference resistor, with the second reference resistor having a higher resistance than the first reference resistor. Responsive to the eFuse being sensed as blown with the second reference resistor, the eFuse is recorded as blown and this completes the screening. Responsive to the eFuse being sensed as unblown with the second reference resistor, the eFuse is recorded as poorly blown.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a schematic diagram illustrating an exemplary sense amplifier for implementing eFuse resistance screening in accordance with the preferred embodiment;

FIG. 2 illustrates an exemplary arrangement of fuse cells with the eFuse sense amplifier of FIG. 1 in accordance with the preferred embodiment;

FIG. 3 illustrates exemplary steps for implementing eFuse resistance screening in accordance with the preferred embodiment; and

FIG. 4 is a flow diagram of a design process used in semiconductor design, manufacturing, and/or test.

### DETAILED DESCRIPTION OF THE PREFERRED EMBODIMENTS

In accordance with features of the invention, a method and circuit for implementing eFuse resistance screening enable quickly and accurately determining if an eFuse is blown properly or not. A sense amplifier circuit includes a plurality of reference resistors having predetermined different resistance values that are selected for implementing eFuse resistance screening. By selecting different reference resistance values, a trip point of the sense amplifier circuit changes enabling eFuse resistance screening. An advantage in this invention is that the requirement to accurately measure the resistance of the eFuse is eliminated and reliability concerns are identified quickly and accurately.

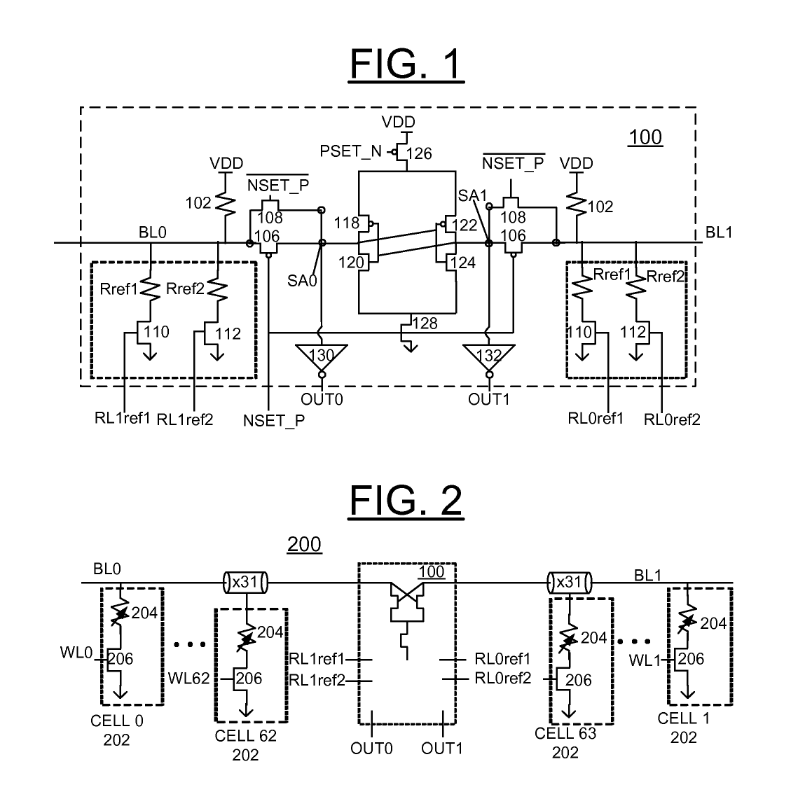

Having reference now to the drawings, in FIG. 1, there is shown an exemplary sense amplifier generally designated by the reference character 100 for implementing eFuse resistance screening in accordance with the preferred embodiment.

Sense amplifier 100 includes a respective resistor pull-up device 102 connected between a positive voltage supply rail VDD and a respective even and odd bitline BL0, BL1. Sense amplifier 100 includes a respective transmission gate defined by a parallel connected P-channel field effect transistor PFET 106 and N-channel field effect transistor NFET 108 connected to the respective even and odd bitline BL0, BL1 and a respective sensing node SA0, SA1.

Sense amplifier 100 includes a plurality of reference resistors Rref1, Rref2, each having predetermined different resistance values, and connected to the respective even and odd bitline BL0, BL1 and connected via a respective NFET 110, 112 to ground. The respective NFETs 110, 112 receive a respective gate input RL1ref1, RL1ref2, and RL0ref1, RL0ref2, as shown. The respectively activated NFET 110 or NFET 112 selects a particular reference resistor value of the reference resistor Rref1, Rref2 for implementing eFuse resistance screening. Reference resistors Rref1, Rref2 have predetermined different resistance values, such as 1K ohm and 4K ohm.

Sense amplifier 100 includes a pair of cross-coupled inverters connected to the sensing nodes SA0, SA1, as shown. A PFET 118 and an NFET 120, and a PFET 122 and an NFET 124 respectively form the cross-coupled inverters. A header PFET 126 connects PFETs 118, 122 to the positive voltage supply rail VDD and a pull-down NFET 128 connects NFETs 122, 126 to ground. A respective inverter 130, 132 coupled to the respective sensing node SA0, SA1 drives a respective output OUT0, OUT1 of the sense amplifier 100.

FIG. 2 illustrates an exemplary eFuse array 200 of a 64-bit column of fuse cells 0-63, 202 with the eFuse sense amplifier 100 of FIG. 1 in accordance with the preferred embodiment. The eFuse array 200 of a 64-bit column of fuse cells 0-63, 202 is balanced bitlines BL0, BL1 on each side of the sense amplifier 100, with 32 even fuse cells 202 per bitline BL0 from fuse cell 0, 202 to fuse cell 62, 303, and 32 odd fuse cells 202 per bitline BL1 from fuse cell 1, 202 to fuse cell 63, 202. Even and odd side of the sense amplifier 100 includes a set of programmable reference resistors, such as the illustrated reference resistors Rref1, Rref2.

Each fuse cell 202 includes an eFuse 204 connected to the respective one of the even and odd bitlines BL0, BL1 and connected via a respective NFET 206 to ground. A respective wordline input WL0-WL63 is applied to a gate input of each NFET 206.

In accordance with features of the invention, one wordline is selected responsive to a particular activated wordline input WL0-WL63 and one reference resistor is selected responsive to reference resistor select input RL1ref1 or RL0ref1, or RL1ref2 or RL0ref2. Then one selected eFuse 204 and one selected reference resistor Rref1 or Rref2 are connected per bitline BL0, BL1.

In accordance with features of the invention, the respective pull up resistors 102 of sense amplifier 100 create a voltage divider between one pull-up resistor 102 and the selected eFuse 204 for example connected to bitline BL1 and a voltage divider between the other pull-up resistor 102 and the selected reference resistor Rref1 or Rref2 connected to bitline BL0. Sense amplifier 100 evaluates the difference between the two voltage dividers and determines if the particular eFuse 204 has a larger or smaller resistance compared to the reference resistor Rref1 or Rref2 to detect either an unblown fuse or a blown fuse.

In accordance with features of the invention, the programmable reference resistor circuit including reference resistors Rref1, Rref2 in the sense amplifier 100 of an eFuse array 200 enables screening out poorly blown eFuses 204 with low post-blow fuse resistance. This programmable reference resistor circuit has multiple settings, such as the illustrated Rref1, Rref2 with each providing unique trip points. Above the trip point the sense amplifier 100 reads as one value (1 or 0) and below is the opposite. The trip point for a given reference setting corresponds to a resistance value. Thus, if the fuse 204 being sensed has a resistance above the reference resistor Rref1 or Rref2, the sense amplifier 100 reads one value and if below the sense amplifier 100 reads the opposite.

Initially, NSET_P signal OFF is directly applied to the transmission-gate PFETs 106, on the even and odd bitline BL0, BL1 sides of the amplifier 100 and is directly applied to pull-down NFET 128. The NSET_P signal is inverted and applied to transmission-gate NFETs 108 on the even and odd bitline BL0, BL1 sides of the amplifier 100. Initially the transmission gate PFETs 106 and NFETs 108 are initially turned on and then are turned off with the NSET_P signal ON. The PSET_N signal is applied to header PFET 126 and is initially ON then changed to PSET_N signal OFF turning on PFET 126 and the sense amplification process commences. After defined time intervals, the header PFET 126 is turned off with PSET_N signal ON and the transmission gate PFETs 106 and NFETs 108 are turned on with the NSET_P signal OFF.

For the sense amplification process, a selected gate input RL1ref1, or RL0ref1 respectively activates a corresponding NFET 110 to selects a lower reference resistor value of the first reference resistor Rref1, for example, connected to bitline BL0 for implementing eFuse resistance screening of a particular selected eFuse 204 connected to bitline BL1. A particular one of WL0-WL63 of the particular fuse cell 0-63 is activated to select the associated eFuse 204.

The first programmable reference Rref1 in the sense amplifier 100 is used to determine if an eFuse resistance is above this particular reference. Then, the eFuse 204 is tested against another, higher resistance reference Rref2. If the eFuse 204 senses above the first reference Rref1, but below the second reference Rref2, this screening indicates the resistance of the particular eFuse 204 is between Resistance #1, Rref1 and Resistance #2, Rref2. This screening consumes much less time and resources than actually measuring the resistance of the particular eFuse 204.

In accordance with features of the invention, this test is used to find low post-blow fuse resistances in eFuses 204. These eFuses 204 are generally considered bad from a reliability standpoint. If a blown fuse senses as blown with the planned reference Rref1, but senses as unblown with a target higher reference Rref2, that eFuse 204 is considered a poorly blown fuse and the part typically should be thrown out.

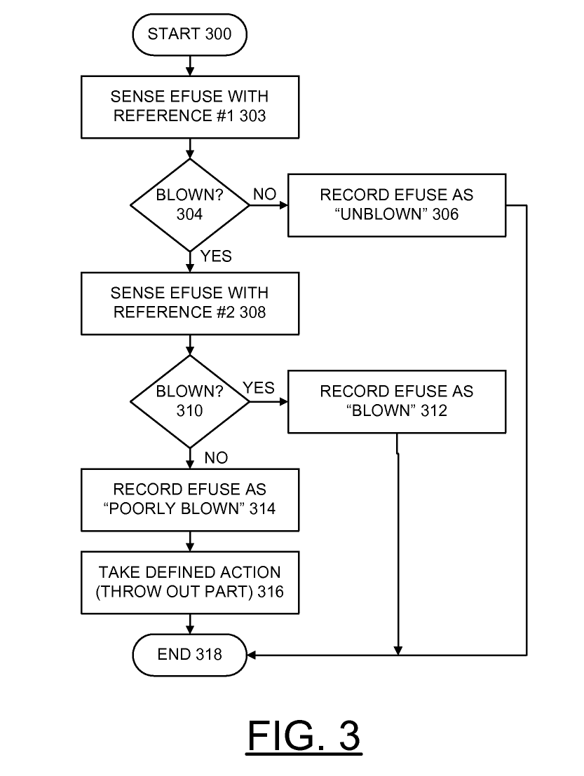

Referring also to FIG. 3, there are shown exemplary steps for implementing eFuse resistance screening of the resistance screening method in accordance with the preferred embodiment starting at a block 300. As indicated at a block 302, an eFuse is sensed with a first reference #1, such as resistor Rref1. The sense amplifier 100 determines if the eFuse is blown as indicated at a decision block 304. If the eFuse senses as unblown with the first reference #1 resistor Rref1, the eFuse is recorded as unblown as indicated at a block 306 and this completes the screening. If the eFuse senses as blown with the first reference #1 resistor Rref1, the eFuse is sensed with a second reference #2, such as resistor Rref2 as indicated at a block 308. The second reference #2 resistor Rref2 has a higher resistance value than the first reference #1 resistor Rref1. The sense amplifier 100 determines if the eFuse is blown as indicated at a decision block 310. If the eFuse senses as blown with the second reference #2 resistor Rref2, the eFuse is recorded as blown as indicated at a block 312 and this completes the screening. If the eFuse senses as unblown with the second reference #2 resistor Rref2, the eFuse is recorded as poorly blown as indicated at a block 314. Then optionally a defined action is taken, such as to throw out the part, as indicated at a block 316. This completes the screening as indicated at a block 318.

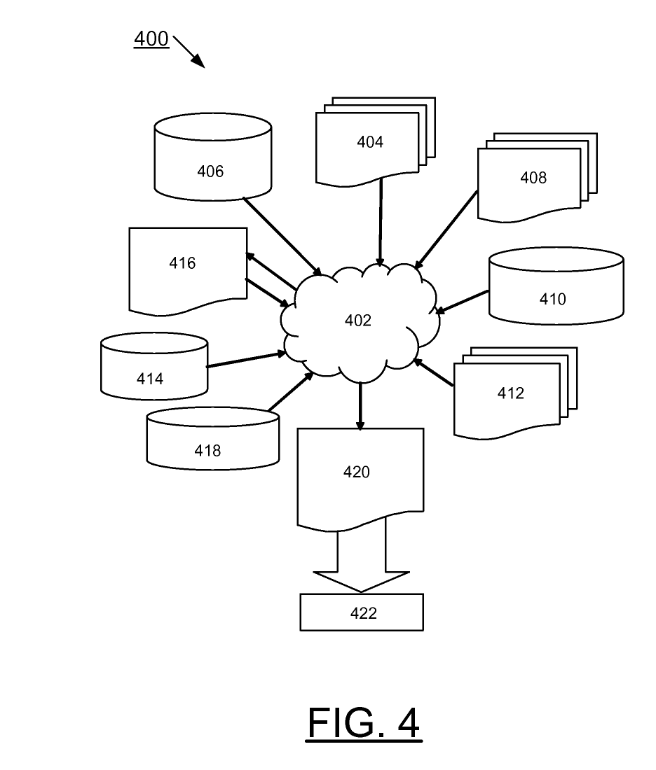

FIG. 4 shows a block diagram of an example design flow 400. Design flow 400 may vary depending on the type of IC being designed. For example, a design flow 400 for building an application specific IC (ASIC) may differ from a design flow 400 for designing a standard component. Design structure 402 is preferably an input to a design process 404 and may come from an IP provider, a core developer, or other design company or may be generated by the operator of the design flow, or from other sources. Design structure 402 comprises circuits 100, 200 in the form of schematics or HDL, a hardware-description language, for example, Verilog, VHDL, C, and the like. Design structure 402 may be contained on one or more machine readable medium. For example, design structure 402 may be a text file or a graphical representation of circuit 100. Design process 404 preferably synthesizes, or translates, circuits 100, 200 into a netlist 406, where netlist 406 is, for example, a list of wires, transistors, logic gates, control circuits, I/O, models, etc. that describes the connections to other elements and circuits in an integrated circuit design and recorded on at least one of machine readable medium. This may be an iterative process in which netlist 406 is resynthesized one or more times depending on design specifications and parameters for the circuit.

Design process 404 may include using a variety of inputs; for example, inputs from library elements 408 which may house a set of commonly used elements, circuits, and devices, including models, layouts, and symbolic representations, for a given manufacturing technology, such as different technology nodes, 32 nm, 45 nm, 90 nm, and the like, design specifications 410, characterization data 412, verification data 414, design rules 416, and test data files 418, which may include test patterns and other testing information.

Design process 404 may further include, for example, standard circuit design processes such as timing analysis, verification, design rule checking, place and route operations, and the like. One of ordinary skill in the art of integrated circuit design can appreciate the extent of possible electronic design automation tools and applications used in design process 404 without deviating from the scope and spirit of the invention. The design structure of the invention is not limited to any specific design flow.

Design process 404 preferably translates an embodiment of the invention as shown in FIGS. 1, 2 and 3 along with any additional integrated circuit design or data (if applicable), into a second design structure 420. Design structure 420 resides on a storage medium in a data format used for the exchange of layout data of integrated circuits, for example, information stored in a GDSII (GDS2), GL1, OASIS, or any other suitable format for storing such design structures. Design structure 420 may comprise information such as, for example, test data files, design content files, manufacturing data, layout parameters, wires, levels of metal, vias, shapes, data for routing through the manufacturing line, and any other data required by a semiconductor manufacturer to produce an embodiment of the invention as shown in FIGS. 1, 2 and 3. Design structure 420 may then proceed to a stage 422 where, for example, design structure 420 proceeds to tape-out, is released to manufacturing, is released to a mask house, is sent to another design house, is sent back to the customer, and the like.

While the present invention has been described with reference to the details of the embodiments of the invention shown in the drawing, these details are not intended to limit the scope of the invention as claimed in the appended claims.

What is claimed is:

1. A method for implementing eFuse resistance screening comprising the steps of:
sensing an eFuse using a first reference resistor;
responsive to the eFuse being sensed as blown with said first reference resistor, sensing the eFuse using a second reference resistor, said second reference resistor having a higher resistance than said first reference resistor; and
responsive to the eFuse being sensed as unblown with said second reference resistor, identifying the eFuse as being poorly blown.

2. The method for implementing eFuse resistance screening as recited in claim 1 includes responsive to the eFuse being sensed as unblown with the first reference resistor, identifying the eFuse as being unblown.

3. The method for implementing eFuse resistance screening as recited in claim 1 includes responsive to the eFuse being sensed as blown with said second reference resistor, identifying the eFuse as being blown.

4. The method for implementing eFuse resistance screening as recited in claim 1 wherein sensing an eFuse using a first reference resistor includes providing a select signal for activating a first transistor connected to said first reference resistor.

5. The method for implementing eFuse resistance screening as recited in claim 4 includes providing a pull-up resistor connected to said first reference resistor; said pull-up resistor and said first reference resistor forming a first reference resistor voltage divider with said activated first transistor.

6. The method for implementing eFuse resistance screening as recited in claim 5 wherein sensing the eFuse using a second reference resistor includes providing a select signal for activating a second transistor connected to said second reference resistor.

7. The method for implementing eFuse resistance screening as recited in claim 6 providing said pull-up resistor connected to said second reference resistor; said pull-up resistor and said second reference resistor forming a second reference resistor voltage divider with said activated second transistor.

8. The method for implementing eFuse resistance screening as recited in claim 7 providing a second pull-up resistor connected to the eFuse, said second pull-up resistor and the eFuse forming an eFuse voltage divider.

9. A circuit for implementing eFuse resistance screening with a sense amplifier comprising:
a plurality of reference resistors;
a respective select transistor connected to each of said plurality of reference resistors;
a first pull-up resistor coupled to said plurality of reference resistors for forming a reference resistor voltage divider;
a second pull-up resistor connected to an eFuse for forming an eFuse voltage divider;
a first reference resistor select signal being applied to a first select transistor connected to a first reference resistor for the sense amplifier sensing the eFuse using said first reference resistor;
a second reference resistor select signal being applied to a second select transistor connected to a second reference resistor for the sense amplifier sensing the eFuse using said second reference resistor, responsive to the sense amplifier sensing the eFuse as being blown with said first reference resistor, said second reference resistor having a higher resistance than said first reference resistor; and
the sense amplifier identifying the eFuse as being poorly blown responsive to the eFuse being sensed as unblown with said second reference resistor.

10. The circuit for implementing eFuse resistance screening as recited in claim 9 includes a first transmission gate coupling said reference resistor voltage divider to a first sense node of the sense amplifier; and a second transmission gate coupling said eFuse voltage divider to a second sense node of the sense amplifier.

11. The circuit for implementing eFuse resistance screening as recited in claim 10 each of said first transmission gate and said second transmission gate includes a parallel connected P-channel field effect transistor (PFET) and N-channel field effect transistor (NFET), a sense amplifier signal control providing a gate input to each said PFET and each said NFET.

12. The circuit for implementing eFuse resistance screening as recited in claim 9 wherein responsive to the eFuse being sensed as unblown with the first reference resistor, the sense amplifier identifies the eFuse as being unblown and completes the eFuse resistance screening.

13. The circuit for implementing eFuse resistance screening as recited in claim 9 wherein responsive to the eFuse being sensed as blown with said second reference resistor, the sense amplifier identifies the eFuse as being blown and completes the eFuse resistance screening.

14. A design structure embodied in a machine readable medium used in a design process, the design structure comprising:
a circuit for implementing eFuse resistance screening with a sense amplifier;
a plurality of reference resistors;
a respective select transistor connected to each of said plurality of reference resistors;
a first pull-up resistor coupled to said plurality of reference resistors for forming a reference resistor voltage divider;
a second pull-up resistor connected to an eFuse for forming an eFuse voltage divider;
a reference resistor select signal being applied to a first select transistor connected to a first reference resistor for the sense amplifier sensing the eFuse using said first reference resistor;
a second reference resistor select signal being applied to a second select transistor connected to a second reference resistor for the sense amplifier sensing the eFuse using said second reference resistor, responsive to the sense amplifier sensing the eFuse as being blown with said first reference resistor, said second reference resistor having a higher resistance than said first reference resistor; and
the sense amplifier identifying the eFuse as being poorly blown responsive to the eFuse being sensed as unblown with said second reference resistor.

15. The design structure of claim 14, wherein the design structure comprises a netlist, which describes the circuit.

16. The design structure of claim 14, wherein the design structure resides on storage medium as a data format used for the exchange of layout data of integrated circuits.

17. The design structure of claim 14, wherein the design structure includes at least one of test data files, characterization data, verification data, or design specifications.

18. The design structure of claim 14, includes a first transmission gate coupling said reference resistor voltage divider to a first sense node of the sense amplifier; and a second transmission gate coupling said eFuse voltage divider to a second sense node of the sense amplifier.

19. The design structure of claim 14, wherein responsive to the eFuse being sensed as unblown with the first reference resistor, the sense amplifier identifies the eFuse as being unblown and completes the eFuse resistance screening.

20. The design structure of claim 14, wherein responsive to the eFuse being sensed as blown with said second reference resistor, the sense amplifier identifies the eFuse as being blown and completes the eFuse resistance screening.
